(19) United States
(12) Patent Application Publication
(10) Pub. No.: US 2025/0063225 A1
(43) Pub. Date: Feb. 20, 2025

(54) VIEW ANGLE SWITCHING METHOD AND APPARATUS, ELECTRONIC DEVICE, STORAGE MEDIUM AND PROGRAM PRODUCT

(71) Applicant: BEIJING BYTEDANCE NETWORK TECHNOLOGY CO., LTD., Beijing (CN)

(72) Inventors: Bin XU, Beijing (CN); Youzhi JIN, Beijing (CN); Shu SHI, Beijing (CN)

(21) Appl. No.: 18/724,571

(22) PCT Filed: Feb. 7, 2023
(86) PCT No.: PCT/CN2023/074745

§ 371 Date: Jun. 26, 2024

(30) Foreign Application Priority Data
Feb. 21, 2022 (CN) 202210158002.8

(51) Int. Cl. H04N 21/443; H04N 21/44

(52) U.S. Cl. CPC H04N 21/4438; H04N 21/44

(57) ABSTRACT

The present disclosure provides a perspective switching method and apparatus, an electronic device, a storage medium, and a program product. The method includes: during a process of playing a current first video stream, in response to a first trigger operation, displaying a perspective navigation window and playing a second video stream in the perspective navigation window, in which navigation video frames in the second video stream are obtained by extracting video frames from different first video streams, and corresponding playback progress of different navigation video frames in respective first video streams is different; and in response to a second trigger operation, taking a target first video stream as a current first video stream and playing the current first video stream, in which the target first video stream is a first video stream having a same perspective as a current navigation video frame displayed in the perspective navigation window.

The present application claims the priority to China Patent Application No. 202210158002.8 filed in China National Intellectual Property Administration on Feb. 21, 2022, the entire disclosure of which is incorporated herein by reference as portion of the present application.

### TECHNICAL FIELD

The present disclosure relates to the field of computer technology, and for example, to a perspective switching method and apparatus, an electronic device, a storage medium, and a program product.

### BACKGROUND

When watching a video, users can switch perspectives to find their preferred one and watch the video from that perspective. Correspondingly, when the client detects a user's operation of switching perspectives, it will stop playing the video of the current perspective, determine the target perspective to which the user wishes to switch, obtain the video stream of the target perspective, and play the video stream of the target perspective on the screen.

However, in the related art, it takes a long time for users to find and switch to their favorite perspectives, which leads to poor user experience.

### SUMMARY

The present disclosure provides a perspective switching method and apparatus, an electronic device, a storage medium, and a program product to reduce the time required for users to find and switch to their favorite perspectives.

In a first aspect, the present disclosure provides a perspective switching method, including:
during a process of playing a current first video stream, in response to a first trigger operation, displaying a perspective navigation window and playing a second video stream in the perspective navigation window, in which the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
in response to a second trigger operation, taking a target first video stream as a current first video stream and playing the current first video stream, in which the second trigger operation is used to instruct switching of the current first video stream, and the target first video stream is a first video stream having a same perspective as a current navigation video frame displayed in the perspective navigation window.

In a second aspect, the present disclosure further provides a perspective switching apparatus, including:
a window display module, configured to, during a process of playing a current first video stream, in response to a first trigger operation, display a perspective navigation window and play a second video stream in the perspective navigation window, in which the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
a first playback module, configured to, in response to a second trigger operation, take a target first video stream as a current first video stream and play the current first video stream, in which the second trigger operation is used to instruct switching of the current first video stream, and the target first video stream is a first video stream having a same perspective as a current navigation video frame displayed in the perspective navigation window.

In a third aspect, the present disclosure further provides an electronic device, including:
one or more processors; and
a memory, configured to store one or more programs,
in which the one or more programs, when executed by the one or more processors, enables the one or more processors to implement the above-mentioned perspective switching methods.

In a fourth aspect, embodiments of the present disclosure further provide a computer-readable storage medium, on which a computer program is stored, and the program, when executed by a processor, implements the above-mentioned perspective switching methods.

In a fifth aspect, the embodiments of the present disclosure further provide a computer program product, and the computer program product, when executed by a computer, enables the computer to implement the above-mentioned perspective switching methods.

### BRIEF DESCRIPTION OF DRAWINGS

FIG. 1 is a schematic flowchart of a perspective switching method provided by the embodiments of the present disclosure;

FIG. 2 is a schematic display diagram of a perspective navigation window provided by the embodiments of the present disclosure;

FIG. 3 is a schematic display diagram of another perspective navigation window provided by the embodiments of the present disclosure;

FIG. 4 is a schematic flowchart of another perspective switching method provided by the embodiments of the present disclosure;

FIG. 5 is a schematic diagram of a perspective navigation bar provided by the embodiments of the present disclosure;

FIG. 6 is a structural block diagram of a perspective switching apparatus provided by the embodiments of the present disclosure; and

FIG. 7 is a schematic structural diagram of an electronic device provided by the embodiments of the present disclosure.

### DETAILED DESCRIPTION

Embodiments of the present disclosure will be described below with reference to the drawings. Although some embodiments of the present disclosure are shown in the drawings, the present disclosure may be embodied in various forms, and these embodiments are provided for understanding the present disclosure. The drawings and embodiments of the present disclosure are for exemplary purposes only.

Various steps described in the method embodiments of the present disclosure may be performed in different orders and/or in parallel. Furthermore, the method embodiments may include additional steps and/or omit performing the illustrated steps. The protection scope of the present disclosure is not limited in this aspect.

As used herein, the term “include,” “comprise,” and variations thereof are open-ended inclusions, i.e., “including but not limited to.” The term “based on” is “based, at least in part, on.” The term “an embodiment” represents “at least one embodiment,” the term “another embodiment” represents “at least one additional embodiment,” and the term “some embodiments” represents “at least some embodiments.” Relevant definitions of other terms will be given in the description below.

Concepts such as the “first,” “second,” or the like mentioned in the present disclosure are only used to distinguish different devices, modules or units, and are not used to limit the interdependence relationship or the order of functions performed by these devices, modules or units.

The modifications of “a,” “an,” “a plurality of,” or the like mentioned in the present disclosure are illustrative rather than restrictive, and those skilled in the art should understand that unless the context clearly indicates otherwise, these modifications should be understood as “one or more.”

The names of the messages or information exchanged between a plurality of apparatuses in the embodiments of the present disclosure are for illustrative purposes only and are not intended to limit the scope of these messages or information.

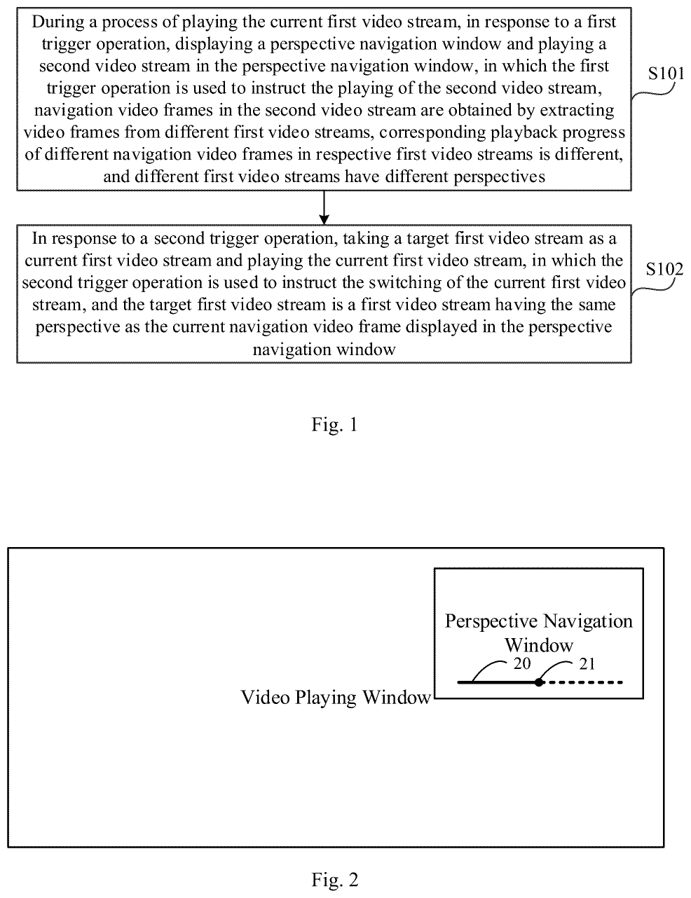

FIG. 1 is a schematic flowchart of a perspective switching method provided by the embodiments of the present disclosure. The method may be executed by a perspective switching apparatus, and the apparatus may be embodied by software and/or hardware and may be configured in an electronic device, for example, the apparatus may be configured in a mobile phone or a tablet computer. The perspective switching method provided by the embodiments of the present disclosure is applicable to scenarios where the viewing perspective is switched, particularly suitable for situations where the viewing perspective of a live broadcast is switched. As shown in FIG. 1, the perspective switching method provided by this embodiment may include:

S101: during a process of playing the current first video stream, in response to a first trigger operation, displaying a perspective navigation window and playing a second video stream in the perspective navigation window, in which the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives.

The current first video stream may be the currently played first video stream. The first video stream may be a video stream captured at a corresponding perspective, that is, a video stream corresponding to a perspective. Different first video streams may correspond to different perspectives, so that users can switch perspectives by switching the first video streams, such as switching the viewing perspective of a video and/or the viewing perspective of a live broadcast.

The first trigger operation may be an operation to instruct the electronic device to play the second video stream, such as a trigger operation acting on a perspective navigation control and/or a trigger operation acting on a perspective navigation bar (such as a perspective navigation slider in the perspective navigation bar). The perspective navigation control and/or the perspective navigation bar may be displayed inside or outside a video playing window for playing the first video stream. The perspective navigation window may be a window for playing the second video stream, which may be different from the above-mentioned video playing window.

The second video stream may include video frames captured from the corresponding perspective of each first video stream, so that users can determine the perspective they want to switch to by looking at the corresponding video frames from different perspectives and switch.

In this embodiment, the server may generate the second video stream according to received video frames of a plurality of first video streams during the live broadcast, or after the video author uploads a plurality of first video streams of a video, the second video stream of the uploaded video may be generated according to the plurality of first video streams.

The second video stream may be composed by sequentially extracting a preset number of video frames from a plurality of perspective video frames in either a clockwise or counterclockwise direction. This extraction is based on a preset video frame interval (i.e., the playback progress interval corresponding to adjacent navigation video frames in the second video stream) and a preset number of extracted frames (i.e., the number of video frames to be extracted each time from the perspective video frames that currently need to be extracted).

For example, if there are m (m is a positive integer) first video streams, and the video frames located in the same position in each first video stream correspond to the same playback progress, and if the preset number of extracted frames is n (n is a positive integer) and the preset video frame interval is p (p is a positive integer) times the video frame interval in the perspective video frame, then the 0-th, p-th, . . . , (n−1) p-th video stream in the first first video stream, the np-th, . . . , (2n−1) p-th video stream in the second first video stream, and the (m−1) np-th, . . . , (mn−1) p-th video frame in the m-th first video frame may be extracted sequentially as navigation video frames in the second video stream; and after extracting the (m−1) np-th, . . . , (mn−1) p-th video frame in the m-th first video frame, return to the first first video stream to extract the mnp-th, . . . , [(m+1) n−1] p-th video stream as video frames in the second video stream, by continuing this process, the second video stream may be obtained.

Taking n and p both as 1 for example, the 0-th video frame in the first perspective video frame, the first video frame in the second perspective video frame, . . . , and the (m−1)-th video frame in the m-th perspective video frame may be extracted sequentially as the video frames in the second video stream. After extracting the (m−1)-th video frame in the m-th first video stream, return to the first first video stream again to extract the m-th video frame in the first first video stream as the video frame in the second video stream, by continuing this process, the second video stream is obtained.

The electronic device plays the current first video stream in the video playing window. Therefore, when the user wants to view the first video stream, for example, when the user wants to find the first video stream they want to switch to based on the second video stream, they may perform the first trigger operation. Accordingly, when receiving the first trigger operation from the user, the electronic device may obtain the second video stream from the server while continuing to play the current first video stream, display the perspective navigation window, and play the second video stream in the perspective navigation window.

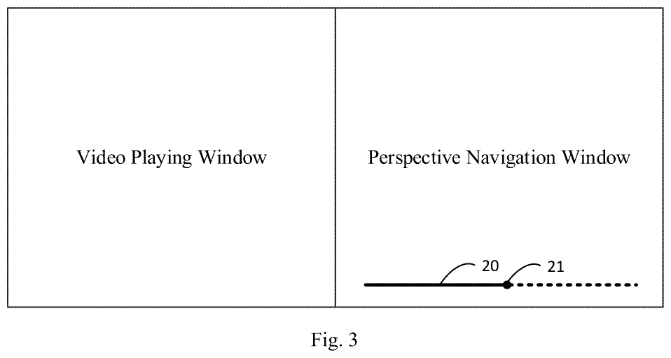

In this embodiment, the display mode of the perspective navigation window may be flexibly set, for example, the perspective navigation window may be displayed as a floating window in the video playing window (as shown in FIG. 2); or the perspective navigation window is created in the current page (i.e., the video playing page), and the size of the video playing window is adjusted according to the size of the perspective navigation window (as shown in FIG. 3); or a navigation window display page may also be displayed, the perspective navigation window is displayed in the navigation window display page, and the current first video stream is continued to be played in the video playing window on the video playing page.

In this embodiment, when the second video stream is played in the perspective navigation window, the playback starting point of the second video stream may be flexibly set, for example, the first video frame of the second video stream may be used as the playback starting point to play the second video stream. The second video stream may be played with the playback progress of the current first video stream played in the video playing window at the current moment (i.e., the current playback progress) as the playback starting point, so that the second video stream played in the perspective navigation window has the same playback progress as the current first video stream played in the video playing window, which provides convenience for users to compare and view the video frames presented in the second video stream with those presented in other first video streams (i.e., the video frames presented in the second video stream), enabling users to quickly determine the first video stream they want to switch to. In this case, playing the second video stream in the perspective navigation window may include playing the second video stream in the perspective navigation window with the same progress as the current playback progress of the current first video stream.

In this embodiment, by playing the second video stream composed of video frames captured from multiple perspectives in the perspective navigation window, users can quickly determine the first video stream they want to switch to while continuing to watch the current first video stream played in the video playing window, without interrupting the playing of the current first video stream in the video playing window or finding the first video stream they want to switch to by repeatedly switching the first video stream, which can reduce the time for users to find and switch to their favorite first video stream, thereby enhancing the user experience.

S102: in response to a second trigger operation, taking a target first video stream as a current first video stream and playing the current first video stream, in which the second trigger operation is used to instruct the switching of the current first video stream, and the target first video stream is a first video stream having the same perspective as the current navigation video frame displayed in the perspective navigation window.

The second trigger operation may be a trigger operation for switching the first video stream, and the second trigger operation is an operation for triggering the perspective switching control, or a click operation acting on the perspective navigation bar. The target first video stream may be a first video stream with the same perspective as the current navigation video frame displayed in the perspective navigation window when receiving the second trigger operation, such as the first video stream to which the current navigation video frame displayed in the perspective navigation window belongs. Accordingly, the current navigation video frame may be the navigation video frame displayed in the video switching window when receiving the second trigger operation.

Exemplarily, the electronic device plays the second video stream in the perspective navigation window. Therefore, the user can view the navigation video frames with different perspectives in the second video stream, and perform the second trigger operation when the user finds a navigation video frame with a satisfactory perspective. Accordingly, when receiving the second trigger operation from the user, the electronic device may determine the current navigation video frame displayed in the perspective navigation window when the second trigger operation is received, acquire the target first video stream to which the current navigation video frame belongs, such as determining the perspective corresponding to the current navigation video frame, acquire the first video stream with the corresponding perspective as the target first video stream, and switch the current first video stream played in the video playing window to the target first video stream.

In this embodiment, after the current first video stream played in the video playing window is switched to the target first video stream, the perspective navigation window may be continuously displayed until receiving a trigger operation to close the perspective navigation window, so as to facilitate the user to switch the current first video stream played in the video playing window again. The perspective navigation window may also be closed, so as to facilitate the user to view the current first video stream played in the video playing window. In this case, after taking the target first video stream as the current first video stream, the method further includes closing the perspective navigation window.

The perspective switching method provided by the present embodiment includes: during the process of playing the current first video stream, in response to the first trigger operation, displaying the perspective navigation window and playing the second video stream in the perspective navigation window, in which the first trigger operation is used to instruct the playing of the second video stream, the navigation video frames in the second video stream are obtained by extracting video frames from different first video streams, the corresponding playback progress of different navigation video frames in respective first video streams is different, and different first video streams have different perspectives; and in response to the second trigger operation, taking the target first video stream, which having the same perspective as the current navigation video frame displayed in the perspective navigation window, as the current first video stream and playing the current first video stream, in which the second trigger operation is used to instruct switching of the current first video stream. By adopting the above-mentioned technical solution, the present embodiment can reduce the time for users to find and switch to their favorite first video stream, thereby enhancing the user experience.

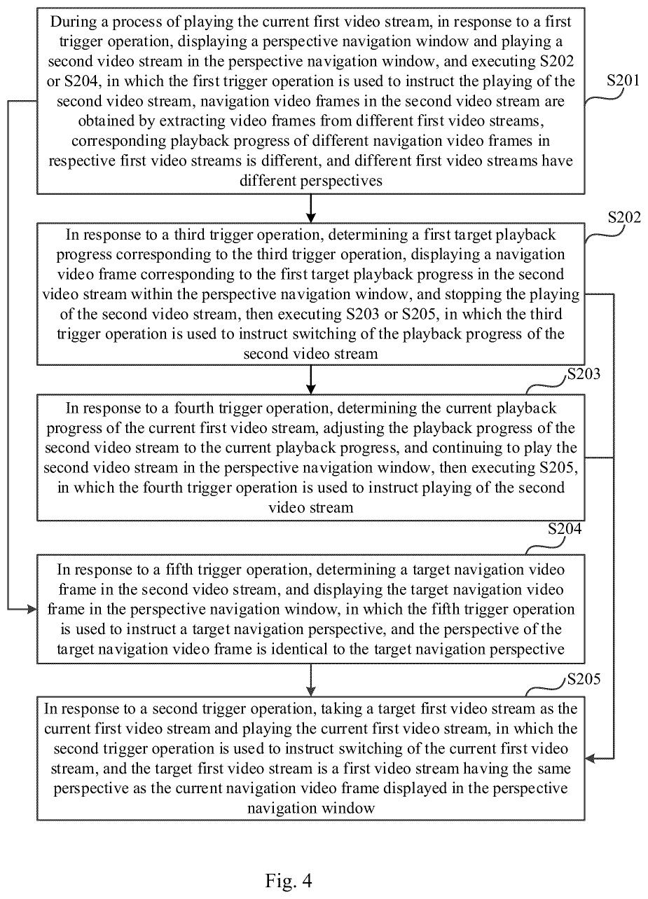

FIG. 4 is a schematic flowchart of another perspective switching method provided by the embodiments of the present disclosure. The solution in this embodiment may be combined with one or more solutions in the above-mentioned embodiments. After playing the second video stream in the perspective navigation window, the method further includes: in response to a third trigger operation, determining a first target playback progress corresponding to the third trigger operation, displaying a navigation video frame corresponding to the first target playback progress in the second video stream within the perspective navigation window, and stopping the playing of the second video stream, in which the third trigger operation is used to instruct switching of the playback progress of the second video stream.

After stopping the playing of the second video stream, the method further includes: in response to a fourth trigger operation, determining the current playback progress of the current first video stream, adjusting the playback progress of the second video stream to the current playback progress, and continuing to play the second video stream in the perspective navigation window, in which the fourth trigger operation is used to instruct playing of the second video stream.

After playing the second video stream in the perspective navigation window, the method further includes: in response to a fifth trigger operation, determining a target navigation video frame in the second video stream, and displaying the target navigation video frame in the perspective navigation window, in which the fifth trigger operation is used to instruct a target navigation perspective, and the perspective of the target navigation video frame is identical to the target navigation perspective.

Accordingly, as shown in FIG. 4, the perspective switching method provided by this embodiment may include:

S201: during a process of playing the current first video stream, in response to a first trigger operation, displaying a perspective navigation window and playing a second video stream in the perspective navigation window, and executing S202 or S204, in which the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives.

S202: in response to a third trigger operation, determining a first target playback progress corresponding to the third trigger operation, displaying a navigation video frame corresponding to the first target playback progress in the second video stream within the perspective navigation window, and stopping the playing of the second video stream, then executing S203 or S205, in which the third trigger operation is used to instruct switching of the playback progress of the second video stream.

The third trigger operation may be a trigger operation to adjust the playback progress of the second video stream, such as a sliding operation in a preset direction (such as horizontal direction) within the perspective navigation window or a position adjustment operation for a progress slider of the second video stream. Accordingly, the first target playback progress may be the playback progress adjusted by the third trigger operation.

If the user wants to adjust the playback progress of the second video stream, the user may perform the third trigger operation. Accordingly, when detecting the third trigger operation from the user, the electronic device may determine the first target playback progress corresponding to the third trigger operation, determine the navigation video frame corresponding to the first target playback progress, that is, determine the navigation video frame in the second video stream whose corresponding playback progress is the first target playback progress, stop playing the second video stream in the perspective navigation window, and display the navigation video frame corresponding to the first target playback progress in the perspective navigation window.

In one embodiment, the third trigger operation includes a position adjustment operation for a progress slider of the second video stream, the method further includes displaying a playback progress bar of the second video stream, and the playback progress bar is provided with the progress slider.

In the above-mentioned embodiment, the user can adjust the playback progress of the second video stream by dragging the progress slider on the playback progress bar of the second video stream.

Exemplarily, when displaying the second video stream in the perspective navigation window, the electronic device may display the playback progress bar 20 of the second video stream, for example, may display the playback progress bar 20 of the second video stream in the perspective navigation window and display the playback progress slider 21 on the playback progress bar 20, as shown in FIG. 2 and FIG. 3. Therefore, when the user wants to adjust the playback progress of the second video stream, the user can drag the progress slider 21. Accordingly, when detecting that the user drags the progress slider 21 of the second video stream, the electronic device may determine that the third trigger operation for the second video stream is received, determine the first target playback progress corresponding to the third trigger operation according to the position of the progress slider 21 of the second video stream on the playback progress bar 20 of the second video stream, display the navigation video frame corresponding to the first target playback progress in the second video stream with the perspective navigation window, and stop playing the second video stream.

In the present embodiment, when the third trigger operation is received, the playing of the second video stream is stopped and the navigation video frame, which corresponding to the playback progress adjusted by the third trigger operation, in the second video stream is displayed, which can avoid the situation that the navigation video frame is displayed only for a short time and is automatically switched to the next navigation video frame for display with the playing of the second video stream, and provides convenience for users to view the navigation video frame corresponding to the corresponding playback progress and further determine whether to switch to the corresponding perspective.

After displaying the navigation video frame corresponding to the first target playback progress, when the third trigger operation for the second video stream is received again, the navigation video frames displayed in the perspective navigation window may be adjusted again based on the third trigger operation, so that users can view different navigation video frames as needed.

S203: in response to a fourth trigger operation, determining the current playback progress of the current first video stream, adjusting the playback progress of the second video stream to the current playback progress, and continuing to play the second video stream in the perspective navigation window, then executing S205, in which the fourth trigger operation is used to instruct playing of the second video stream.

In the present embodiment, when the user performs the fourth trigger operation for the second video stream, the second video stream may continue to play in the perspective navigation window with the current playback progress to which the current first video stream is played as the playback starting point, so that the user can continue to compare and view the video frames in the currently played video stream and the video frames in the second video stream under the corresponding playback progress.

The fourth trigger operation may be an operation to continue playing the second video stream, such as an operation to trigger a playback control of the second video stream.

After viewing the navigation video frame corresponding to the first target playback progress, if the user wants to continue watching the second video stream, the user may perform the fourth trigger operation, such as trigger the playback control of the second video stream. Accordingly, when receiving the fourth trigger operation for the second video stream from the user, the electronic device may determine the current playback progress of the current first video stream played in the video playing window, adjust the playback progress of the second video stream according to the current playback progress, and continue to play the second video stream in the perspective navigation window according to the adjusted playback progress.

S204: in response to a fifth trigger operation, determining a target navigation video frame in the second video stream, and displaying the target navigation video frame in the perspective navigation window, in which the fifth trigger operation is used to instruct a target navigation perspective, and the perspective of the target navigation video frame is identical to the target navigation perspective.

The fifth trigger operation may be an operation of selecting a perspective for navigation, such as an operation of adjusting the position of the perspective navigation slider on the perspective navigation bar or an operation of selecting one of the displayed perspectives as the navigation perspective. The target navigation perspective may be the perspective selected by the fifth trigger operation. The target navigation video frame may be a navigation video frame, which having the same perspective as the target navigation perspective, in the second video stream.

The electronic device plays the second video stream in the perspective navigation window. Therefore, when the user wants to view the video frame of a certain perspective in the second video stream, the user may perform the fifth trigger operation, such as selecting the certain perspective as the navigation perspective. Accordingly, when receiving the fifth trigger operation from the user, the electronic device may take the perspective targeted by the fifth trigger operation as the navigation perspective, acquire the target navigation video frame in the second video stream whose perspective is identical to the navigation perspective, and display the target navigation video frames in the perspective navigation window, for example, a plurality of target navigation video frames may be displayed sequentially, or according to the current playback progress of the current first video stream, the target navigation video frame whose corresponding playback progress is closest to the current playback progress of the current first video stream is displayed in the perspective navigation window, and so on.

In the present embodiment, when the fifth trigger operation is received, the navigation video frame corresponding to the navigation perspective selected by the user may be shown to the user in the perspective navigation window, so that the user can determine whether to switch the current first video stream to the first video stream corresponding to this perspective by viewing different navigation video frames under this perspective, which can provide convenience for the user to determine the first video stream to be switched to and improve the user experience.

In one embodiment, the fifth trigger operation includes a position adjustment operation for a perspective navigation slider, the method further includes displaying a perspective navigation bar, the perspective navigation bar is provided with the perspective navigation slider, and different positions of the perspective navigation bar correspond to different perspectives; and before determining the target navigation video frame in the second video stream, the method further includes taking the perspective indicated by the perspective navigation slider on the perspective navigation bar as the target navigation perspective.

In the above-mentioned embodiment, the user may perform the second trigger operation by dragging the perspective navigation slider on the perspective navigation bar.

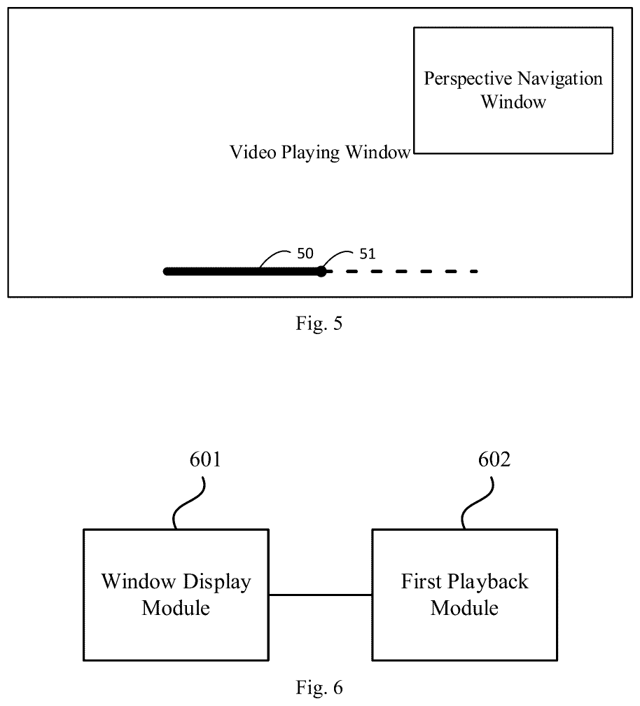

Exemplarily, the electronic device may display the perspective navigation bar 50 when playing the second video stream in the perspective navigation window, or when playing the current first video stream in the video playing window, for example, the perspective navigation bar 50 may be displayed in the video playing window, and the perspective navigation slider 51 may be displayed on the perspective navigation bar 50, as shown in FIG. 5 (in the figure, the perspective navigation window is displayed in the form of a floating window as an example). Therefore, when the user wants to view the navigation video frame of a perspective, the user may drag the perspective navigation slider 51 to the position corresponding to the perspective. Accordingly, when detecting that the user drags the perspective navigation slider 51 on the perspective navigation bar 50, the electronic device may determine that the fifth trigger operation is received, determine the target navigation perspective according to the position of the perspective navigation slider 51 on the perspective navigation bar 50, for example, take the perspective indicated by the perspective navigation slider 51 on the perspective navigation bar 50 as the target navigation perspective, acquire the target navigation video frame in the second video stream whose perspective is the target navigation perspective, and display the acquired target navigation video frame in the perspective navigation window.

In the present embodiment, the target navigation video frame may be displayed according to the current playback progress of the current first video stream, for example, the target video frame which is closest to the current playback progress of the current first video stream and whose corresponding playback progress is before or identical to the current playback progress may be displayed. In this case, displaying the target navigation video frame in the perspective navigation window includes: acquiring the current target navigation video frame according to the current playback progress of the current first video stream, and displaying the current target navigation video frame in the perspective navigation window, in which the current target navigation video frame is a target navigation video frame, whose corresponding second target playback progress is less than or equal to the current playback progress, having the minimum absolute value of a difference in progress from the current playback progress. Here, the current target navigation video frame may be a target navigation video frame which is determined according to the current playback progress of the current first video stream and needs to be displayed in the perspective navigation window at the current moment, and may be a target video frame which is closest to the current playback progress of the current first video stream and whose corresponding playback progress is before or identical to the current playback progress. Accordingly, the second target playback progress is the playback progress corresponding to the target navigation video frame.

S205: in response to a second trigger operation, taking a target first video stream as the current first video stream and playing the current first video stream, in which the second trigger operation is used to instruct switching of the current first video stream, and the target first video stream is a first video stream having the same perspective as the current navigation video frame displayed in the perspective navigation window.

In one embodiment, the electronic device may play the current first video stream in the video playing window and display a perspective navigation control. When the user wants to view the second video stream, the perspective navigation control may be triggered. Accordingly, when detecting that the user triggers the perspective navigation control, the electronic device may display the perspective navigation window, play the second video stream in the perspective navigation window according to the current playback progress of the current first video stream, and display the playback progress bar and the perspective switching control of the second video stream in the perspective navigation window. Therefore, the user can perform the third trigger operation by dragging the progress slider on the playback progress bar to instruct the electronic device to display the navigation video frame at the corresponding playback progress in the perspective navigation window; and can perform the second trigger operation by triggering the perspective switching control to instruct the electronic device to switch the current first video stream played in the video playing window to the target first video stream to which the video frame displayed in the perspective navigation window at the current moment belongs.

In another embodiment, the electronic device may play the current first video stream in the video playing window and display the perspective navigation bar. Therefore, the user can instruct the electronic device to display the target navigation video frame of the corresponding perspective by dragging the perspective navigation slider on the perspective navigation bar, and can switch the current first video stream played in the video playing window by clicking the perspective navigation slider on the perspective navigation bar.

For example, when detecting a press event acting on the perspective navigation slider, the electronic device may display the perspective navigation window and play the second video stream in the perspective navigation window according to the current playback progress of the current first video stream.

If a drag event corresponding to the press event is detected after the press event, the position of the perspective navigation slider on the perspective navigation bar may be adjusted based on the drag event, the target navigation perspective may be determined according to the position, and the navigation video frame with the same perspective as the target navigation perspective may be displayed in the perspective navigation window. When the user stops dragging the perspective navigation slider, such as when a release event is detected after the drag event, the current first video stream may not be switched, and the corresponding navigation video frame may continue to be displayed in the perspective navigation window; or the current first video stream may also be switched, for example, the perspective indicated by the perspective navigation slider when the release event is received may be taken as a perspective to be switched, the target first video stream with the same perspective as the perspective to be switched may be acquired, and the current first video stream played in the video playing window may be switched to the target first video stream.

If a release event corresponding to the press event is detected after the press event, that is, when a click operation acting on the perspective navigation slider is received, the perspective indicated by the perspective navigation slider when the release event is received may be taken as the perspective to be switched, the target first video stream with the same perspective as the perspective to be switched may be acquired, and the current first video stream played in the video playing window may be switched to the target first video stream.

In addition, an undo gesture may be preset, for example, a gesture of sliding in a set direction (such as up or down) may be set as an undo gesture, so that the user can undo the switching of the current first video stream during the above-mentioned drag operation or click operation. For example, if a preset undo gesture is detected instead of a release event after the above-mentioned press event or drag event, the display of the perspective navigation window may be stopped and the current first video stream may continue to be played in the video playing window.

Based on the trigger operation from the user, the perspective switching method provided by the present embodiment displays the navigation video frame of the corresponding perspective in the video playing window, which can provide convenience for the user to determine the first video stream to be switched to and improve the user experience.

FIG. 6 is a structural block diagram of a perspective switching apparatus provided by the embodiments of the present disclosure. The apparatus may be implemented by software and/or hardware, and may be configured in an electronic device, for example, the apparatus may be configured in a mobile phone or a tablet computer, and the perspective may be switched by performing the perspective switching method. As shown in FIG. 6, the perspective switching apparatus provided by this embodiment may include a window display module 601 and a first playback module 602.

The window display module 601 is configured to, during a process of playing the current first video stream, in response to a first trigger operation, display a perspective navigation window and play a second video stream in the perspective navigation window, in which the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives. The first playback module 602 is configured to, in response to a second trigger operation, take a target first video stream as the current first video stream and play the current first video stream, in which the second trigger operation is used to instruct switching of the current first video stream, and the target first video stream is a first video stream having the same perspective as the current navigation video frame displayed in the perspective navigation window.

According to the perspective switching apparatus provided by the present embodiment, by the window display module 601, during the process of playing the current first video stream, in response to the first trigger operation, displaying the perspective navigation window and playing the second video stream in the perspective navigation window, in which the first trigger operation is used to instruct the playing of the second video stream, the navigation video frames in the second video stream are obtained by extracting video frames from different first video streams, the corresponding playback progress of different navigation video frames in respective first video streams is different, and different first video streams have different perspectives; and by the first playback module 602, in response to the second trigger operation, taking the target first video stream, which having the same perspective as the current navigation video frame displayed in the perspective navigation window, as the current first video stream and playing the current first video stream, in which the second trigger operation is used to instruct switching of the current first video stream. By adopting the above-mentioned technical solution, the present embodiment can reduce the time for users to find and switch to their favorite first video stream, thereby enhancing the user experience.

In the above-mentioned solution, the window display module 601 may be configured to play the second video stream in the perspective navigation window with the same progress as a current playback progress of the current first video stream.

The perspective switching apparatus provided by the present embodiment may further include a window closing module configured to close the perspective navigation window after taking the target first video stream as the current first video stream.

The perspective switching apparatus provided by the present embodiment may further include a progress adjustment module, which is configured to, after playing the second video stream in the perspective navigation window, in response to a third trigger operation, determine a first target playback progress corresponding to the third trigger operation, display a navigation video frame corresponding to the first target playback progress in the second video stream within the perspective navigation window, and stop the playing of the second video stream, where the third trigger operation is used to instruct switching of the playback progress of the second video stream

In the above-mentioned solution, the third trigger operation may include a position adjustment operation for a progress slider of the second video stream, and the window display module 601 may further be configured to display a playback progress bar of the second video stream, and the playback progress bar is provided with the progress slider.

The perspective switching apparatus provided by the present embodiment may further include a second playback module, which is configured to, after stopping the playing of the second video stream, in response to a fourth trigger operation, determine the current playback progress of the current first video stream, adjust the playback progress of the second video stream to the current playback progress, and continue to play the second video stream in the perspective navigation window, where the fourth trigger operation is used to instruct playing of the second video stream.

In the above-mentioned solution, the first trigger operation may include a trigger operation acting on a perspective navigation control.

The perspective switching apparatus provided by the present embodiment may further include a video frame display module, which is configured to, after playing the second video stream in the perspective navigation window, in response to a fifth trigger operation, determine a target navigation video frame in the second video stream, and display the target navigation video frame in the perspective navigation window, where the fifth trigger operation is used to instruct a target navigation perspective, and a perspective of the target navigation video frame is identical to the target navigation perspective.

In the above-mentioned solution, the video frame display module may be configured to acquire the current target navigation video frame according to the current playback progress of the current first video stream, and display the current target navigation video frame in the perspective navigation window, where the current target navigation video frame is a target navigation video frame, whose corresponding second target playback progress is less than or equal to the current playback progress, having a minimum absolute value of a difference in progress from the current playback progress.

In the above-mentioned solution, the fifth trigger operation may include a position adjustment operation for a perspective navigation slider, and the perspective switching apparatus provided by the present embodiment may further include a navigation bar display module configured to display a perspective navigation bar, where the perspective navigation bar is provided with the perspective navigation slider, and different positions of the perspective navigation bar correspond to different perspectives; and the video frame display module may be further configured to, before determining the target navigation video frame in the second video stream, take a perspective indicated by the perspective navigation slider on the perspective navigation bar as the target navigation perspective.

In the above-mentioned solution, the first trigger operation may include a trigger operation acting on the perspective navigation bar; and/or the second trigger operation may include a click operation acting on the perspective navigation bar.

The perspective switching apparatus provided by the embodiment of the present disclosure can execute the perspective switching method provided by any embodiment of the present disclosure, and has corresponding functional modules and effects for executing the perspective switching method. For technical details that are not described in detail in the present embodiment, please refer to the perspective switching method provided by any embodiment of the present disclosure.

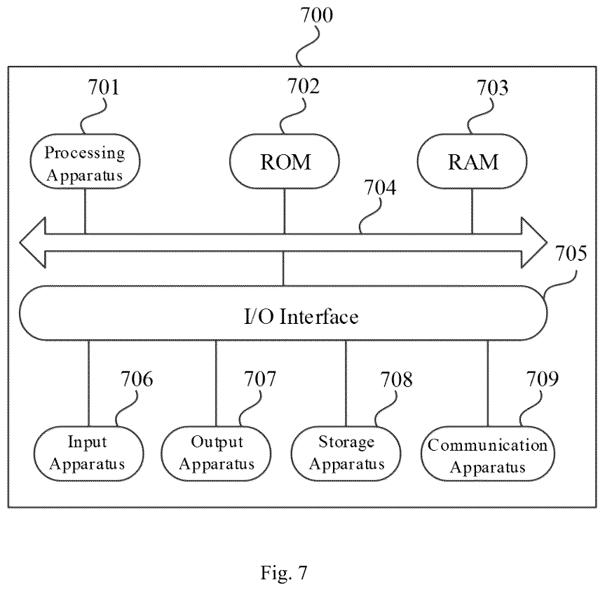

Referring to FIG. 7, FIG. 7 illustrates a schematic structural diagram of an electronic device 700 (such as a terminal device) suitable for implementing the embodiments of the present disclosure. The electronic devices in the embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), and fixed terminals such as a digital TV, a desktop computer, or the like. The electronic device illustrated in FIG. 7 is merely an example, and should not pose any limitation to the functions and the range of use of the embodiments of the present disclosure.

As illustrated in FIG. 7, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected through a bus 704. An input/output (I/O) interface 705 is also connected to the bus 704.

Usually, the following apparatuses may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

According to the embodiments of the present disclosure, the processes described above with reference to the flowcharts may be implemented as a computer software program. For example, the embodiments of the present disclosure include a computer program product, which includes a computer program carried by a non-transitory computer-readable medium. The computer program includes program code for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present disclosure are performed.

The above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program code. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: during a process of playing the current first video stream, in response to a first trigger operation, display a perspective navigation window and play a second video stream in the perspective navigation window, where the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and in response to a second trigger operation, take a target first video stream as the current first video stream and playing the current first video stream, where the second trigger operation is used to instruct switching of the current first video stream, and the target first video stream is a first video stream having a same perspective as the current navigation video frame displayed in the perspective navigation window.

The computer program code for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the drawings illustrate the architecture, function, and operation of possible implementations of systems, methods, and computer program products according to various embodiments of the present disclosure. In this regard, each block in the flowcharts or block diagrams may represent a module, a program segment, or a portion of code, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present disclosure may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present disclosure, Example 1 provides a perspective switching method, including:
during a process of playing a current first video stream, in response to a first trigger operation, displaying a perspective navigation window and playing a second video stream in the perspective navigation window, where the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
in response to a second trigger operation, taking a target first video stream as a current first video stream and playing the current first video stream, where the second trigger operation is used to instruct switching of the current first video stream, and the target first video stream is a first video stream having a same perspective as a current navigation video frame displayed in the perspective navigation window.

According to one or more embodiments of the present disclosure, in the method provided by Example 2 according to Example 1, the playing the second video stream in the perspective navigation window includes:
playing the second video stream in the perspective navigation window with a same progress as a current playback progress of the current first video stream.

According to one or more embodiments of the present disclosure, the method provided by Example 3 according to Example 1, after taking the target first video stream as the current first video stream, further including:
closing the perspective navigation window.

According to one or more embodiments of the present disclosure, the method provided by Example 4 according to any one of Examples 1-3, after playing the second video stream in the perspective navigation window, further including:
in response to a third trigger operation, determining a first target playback progress corresponding to the third trigger operation, displaying a navigation video frame corresponding to the first target playback progress in the second video stream within the perspective navigation window, and stopping the playing of the second video stream, where the third trigger operation is used to instruct switching of a playback progress of the second video stream.

According to one or more embodiments of the present disclosure, in the method provided by Example 5 according to Example 4, the third trigger operation includes a position adjustment operation for a progress slider of the second video stream, and the method further includes:
displaying a playback progress bar of the second video stream, where the playback progress bar is provided with the progress slider.

According to one or more embodiments of the present disclosure, in the method provided by Example 6 according to Example 4, after stopping the playing of the second video stream, the method further includes:
in response to a fourth trigger operation, determining a current playback progress of the current first video stream, adjusting the playback progress of the second video stream to the current playback progress, and continuing to play the second video stream in the perspective navigation window, where the fourth trigger operation is used to instruct playing of the second video stream.

According to one or more embodiments of the present disclosure, in the method provided by Example 7 according to Example 4, the first trigger operation includes a trigger operation acting on a perspective navigation control.

According to one or more embodiments of the present disclosure, the method provided by Example 8 according to any one of Examples 1-3, after playing the second video stream in the perspective navigation window, further including:
in response to a fifth trigger operation, determining a target navigation video frame in the second video stream, and displaying the target navigation video frame in the perspective navigation window, where the fifth trigger operation is used to instruct a target navigation perspective, and a perspective of the target navigation video frame is identical to the target navigation perspective.

According to one or more embodiments of the present disclosure, in the method provided by Example 9 according to Example 8, the displaying the target navigation video frame in the perspective navigation window includes:
acquiring a current target navigation video frame according to a current playback progress of the current first video stream, and displaying the current target navigation video frame in the perspective navigation window, where the current target navigation video frame is a target navigation video frame, whose corresponding second target playback progress is less than or equal to the current playback progress, having a minimum absolute value of a difference in progress from the current playback progress.

According to one or more embodiments of the present disclosure, in the method provided by Example 10 according to Example 8, the fifth trigger operation includes a position adjustment operation for a perspective navigation slider, and the method further includes:
displaying a perspective navigation bar, where the perspective navigation bar is provided with the perspective navigation slider, and different positions of the perspective navigation bar correspond to different perspectives;
and before determining the target navigation video frame in the second video stream, the method further includes:
taking a perspective indicated by the perspective navigation slider on the perspective navigation bar as the target navigation perspective.

According to one or more embodiments of the present disclosure, in the method provided by Example 11 according to Example 10, the first trigger operation includes a trigger operation acting on the perspective navigation bar; and/or the second trigger operation includes a click operation acting on the perspective navigation bar.

According to one or more embodiments of the present disclosure, Example 12 provides a perspective switching apparatus, including:
a window display module, configured to, during a process of playing a current first video stream, in response to a first trigger operation, display a perspective navigation window and play a second video stream in the perspective navigation window, where the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
a first playback module, configured to, in response to a second trigger operation, take a target first video stream as a current first video stream and play the current first video stream, where the second trigger operation is used to instruct switching of the current first video stream, and the target first video stream is a first video stream having a same perspective as a current navigation video frame displayed in the perspective navigation window.

According to one or more embodiments of the present disclosure, Example 13 provides an electronic device, including:
at least one processor; and
a memory, configured to store at least one program,
where the at least one program, when executed by the at least one processor, enables the at least one processor to implement the perspective switching method according to any one of Examples 1-11.

According to one or more embodiments of the present disclosure, Example 14 provides a computer-readable storage medium, storing a computer program, where the program, when executed by a processor, implements the perspective switching method according to any one of Examples 1-11.

According to one or more embodiments of the present disclosure, Example 15 provides a computer program product, and the computer program product, when executed by a computer, enables the computer to implement the perspective switching method according to any one of Examples 1-11.

Additionally, although operations are depicted in a particular order, it should not be understood that these operations are required to be performed in a specific order as illustrated or in a sequential order. Under certain circumstances, multitasking and parallel processing may be advantageous. Likewise, although the above discussion includes several specific implementation details, these should not be interpreted as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combinations.

1. A perspective switching method, comprising:
during a process of playing a current first video stream, in response to a first trigger operation, displaying a perspective navigation window and playing a second video stream in the perspective navigation window, wherein the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
in response to a second trigger operation, taking a target first video stream as a current first video stream and playing the current first video stream, wherein the second trigger operation is used to instruct switching of the current first video stream, and the target first video stream is a first video stream having a same perspective as a current navigation video frame displayed in the perspective navigation window.

2. The method according to claim 1, wherein the playing the second video stream in the perspective navigation window comprises:
playing the second video stream in the perspective navigation window with a same progress as a current playback progress of the current first video stream.

3. The method according to claim 1, after taking the target first video stream as the current first video stream, further comprising:
closing the perspective navigation window.

4. The method according to claim 1, after playing the second video stream in the perspective navigation window, further comprising:
in response to a third trigger operation, determining a first target playback progress corresponding to the third trigger operation, displaying a navigation video frame corresponding to the first target playback progress in the second video stream within the perspective navigation window, and stopping the playing of the second video stream, wherein the third trigger operation is used to instruct switching of a playback progress of the second video stream.

5. The method according to claim 4, wherein the third trigger operation comprises a position adjustment operation for a progress slider of the second video stream, and the method further comprises:
displaying a playback progress bar of the second video stream, wherein the playback progress bar is provided with the progress slider.

6. The method according to claim 4, after stopping the playing of the second video stream, further comprising:
in response to a fourth trigger operation, determining a current playback progress of the current first video stream, adjusting the playback progress of the second video stream to the current playback progress, and continuing to play the second video stream in the perspective navigation window, wherein the fourth trigger operation is used to instruct playing of the second video stream.

7. The method according to claim 4, wherein the first trigger operation comprises a trigger operation acting on a perspective navigation control.

8. The method according to claim 1, after playing the second video stream in the perspective navigation window, further comprising:
in response to a fifth trigger operation, determining a target navigation video frame in the second video stream, and displaying the target navigation video frame in the perspective navigation window, wherein the fifth trigger operation is used to instruct a target navigation perspective, and a perspective of the target navigation video frame is identical to the target navigation perspective.

9. The method according to claim 8, wherein the displaying the target navigation video frame in the perspective navigation window comprises:
acquiring a current target navigation video frame according to a current playback progress of the current first video stream, and displaying the current target navigation video frame in the perspective navigation window, wherein the current target navigation video frame is a target navigation video frame, whose corresponding second target playback progress is less than or equal to the current playback progress, having a minimum absolute value of a difference in progress from the current playback progress.

10. The method according to claim 8, wherein the fifth trigger operation comprises a position adjustment operation for a perspective navigation slider, and the method further comprises:
displaying a perspective navigation bar, wherein the perspective navigation bar is provided with the perspective navigation slider, and different positions of the perspective navigation bar correspond to different perspectives;
before determining the target navigation video frame in the second video stream, the method further comprises:
taking a perspective indicated by the perspective navigation slider on the perspective navigation bar as the target navigation perspective.

11. The method according to claim 10, wherein at least one as follows is satisfied:
the first trigger operation comprises a trigger operation acting on the perspective navigation bar;
the second trigger operation comprises a click operation acting on the perspective navigation bar.

12. (canceled)

13. An electronic device, comprising:
at least one processor; and
a memory, configured to store at least one program,
wherein the at least one program, when executed by the at least one processor, enables the at least one processor to implement a perspective switching method, and the perspective switching method comprises:
during a process of playing a current first video stream, in response to a first trigger operation, displaying a perspective navigation window and playing a second video stream in the perspective navigation window, wherein the first trigger operation is used to instruct the playing of the second video stream, navigation video frames in the second video stream are obtained by extracting video frames from different first video streams, corresponding playback progress of different navigation video frames in respective first video streams is different, and different first video streams have different perspectives; and
in response to a second trigger operation, taking a target first video stream as a current first video stream and playing the current first video stream, wherein the second trigger operation is used to instruct switching of the current first video stream, and the target first video stream is a first video stream having a same perspective as a current navigation video frame displayed in the perspective navigation window.

14. A computer-readable storage medium, storing a computer program, wherein the computer program, when executed by a processor, implements the perspective switching method according to claim 1.

15. (canceled)

16. The method according to claim 2, after playing the second video stream in the perspective navigation window, further comprising:
in response to a third trigger operation, determining a first target playback progress corresponding to the third trigger operation, displaying a navigation video frame corresponding to the first target playback progress in the second video stream within the perspective navigation window, and stopping the playing of the second video stream, wherein the third trigger operation is used to instruct switching of a playback progress of the second video stream.

17. The method according to claim 3, after playing the second video stream in the perspective navigation window, further comprising:
in response to a third trigger operation, determining a first target playback progress corresponding to the third trigger operation, displaying a navigation video frame corresponding to the first target playback progress in the second video stream within the perspective navigation window, and stopping the playing of the second video stream, wherein the third trigger operation is used to instruct switching of a playback progress of the second video stream.

18. The method according to claim 2, after playing the second video stream in the perspective navigation window, further comprising:
in response to a fifth trigger operation, determining a target navigation video frame in the second video stream, and displaying the target navigation video frame in the perspective navigation window, wherein the fifth trigger operation is used to instruct a target navigation perspective, and a perspective of the target navigation video frame is identical to the target navigation perspective.

19. The method according to claim 3, after playing the second video stream in the perspective navigation window, further comprising:
in response to a fifth trigger operation, determining a target navigation video frame in the second video stream, and displaying the target navigation video frame in the perspective navigation window, wherein the fifth trigger operation is used to instruct a target navigation perspective, and a perspective of the target navigation video frame is identical to the target navigation perspective.

20. The electronic device according to claim 13, wherein the playing the second video stream in the perspective navigation window comprises:
playing the second video stream in the perspective navigation window with a same progress as a current playback progress of the current first video stream.

21. The electronic device according to claim 13, wherein after taking the target first video stream as the current first video stream, the perspective switching method further comprises:
closing the perspective navigation window.

22. The electronic device according to claim 13, wherein after playing the second video stream in the perspective navigation window, the perspective switching method further comprises:
in response to a third trigger operation, determining a first target playback progress corresponding to the third trigger operation, displaying a navigation video frame corresponding to the first target playback progress in the second video stream within the perspective navigation window, and stopping the playing of the second video stream, wherein the third trigger operation is used to instruct switching of a playback progress of the second video stream.
